(19) United States
(12) Patent Application Publication
(10) Pub. No.: US 2021/0233113 A1
(43) Pub. Date: Jul. 29, 2021

(54) MULTI-DIMENSIONAL PACING FORECAST OF ELECTRONIC DISTRIBUTION OF CONTENT ITEMS

(71) Applicant: Microsoft Technology Licensing, LLC, Redmond, WA (US)

(72) Inventors: He Ren, San Jose, CA (US); Sudhanshu Garg, San Francisco, CA (US); Vaijayanth Raghavan, San Jose, CA (US); Yue Huang, Sunnyvale, CA (US); Christopher D. Erbach, Palo Alto, CA (US); Shaunak Shatmanyu, Fremont, CA (US)

(21) Appl. No.: 16/774,169

(22) Filed: Jan. 28, 2020

(51) Int. Cl. G06Q 30/02; G06N 7/00; G06N 20/00

(52) U.S. Cl. CPC G06Q 30/0264; G06Q 30/0242; G06N 20/00; G06Q 30/0261; G06N 7/005; G06Q 30/0275

(57) ABSTRACT

Herein are techniques for content delivery pacing based on multidimensional forecasting. In an embodiment, a computer receives, for a content delivery campaign, targeting criteria and a resource usage limit of a limited resource. Entities that match the targeting criteria are identified for which content of the delivery campaign may have increased relevance. For each matching entity, a forecast of requests that might originate from the entity during each of a series of time intervals is generated to predict opportunities to deliver the content of the campaign. The forecasts of the matching entities can be combined to generate a combined forecast of requests for the targeting criteria. The computer generates, based on the combined forecast and the resource usage limit for the content delivery campaign, and stores for future use a fulfilment schedule that specifies amounts of requests to fulfill during the series of time intervals.

### TECHNICAL FIELD

The present disclosure relates generally to content delivery pacing and, more particularly, to campaign pacing based on multi-dimensional forecasting.

### BACKGROUND

Forecasting delivery rate of an online content delivery campaign is difficult for various reasons. One such reason is accuracy of traffic predictions. For example, campaign owners may be expected to accept that forecasted volume and actual volume may diverge by as much as twenty percent during the life of a content delivery campaign. Even if overall online activity may have certain patterns, online behavior of individual users and segments of users may change significantly over time and might not exhibit any noticeable pattern. Thus, forecasting delivery rate of a targeted content delivery campaign during a certain future time interval, may have huge errors, such as 5×. For example, if a forecasted delivery rate is one hundred units in a future time interval, then the actual delivery rate is too often twenty units or five hundred units when that time interval occurs.

Forecasting the delivery rate of campaign content is vital, at least due to the following reasons. Some of those reasons illustrate why forecasting a delivery rate is non-trivial and at risk of interference such as by other content delivery campaigns.
High performing campaigns exceed delivery expectations early and discontinue delivery for the rest of the day (for example, due to delivery quota fulfilment).
Multiple campaigns may be suited for the same member inventory. As campaigns stop delivering, interference reduces, which increasingly causes less suitable content to be displayed to members as time progresses. As campaigns stop delivering, it also affects the forecasted delivery for other campaigns.
Priority inventory/members might visit later in the day, when high performing campaigns that are more relevant to such members have already been exhausted.
Overdelivery: By eagerly serving campaigns as quickly as possible, and not accommodating a delay in a progress update for a campaign, more impressions/clicks for the campaign may be delivered than what was expected, thereby losing an opportunity to deliver content of other campaigns instead.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2 is a block diagram that depicts an example computer that, based on multidimensional targeting and forecasting, generates a fulfillment schedule that maintains a smooth pace of request fulfilment for a content delivery campaign, in an embodiment;

FIG. 3 is a flow diagram that depicts an example analytical process for calculating a fulfillment schedule for a content delivery campaign, in an embodiment;

FIG. 4 is a flow diagram that depicts an example transactional process for using a fulfillment schedule to pace impressions of a content delivery campaign, in an embodiment;

FIG. 5 is a flow diagram that depicts an example analytical process for generating a fulfillment schedule to pace impressions of content delivery campaign, in an embodiment;

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Herein are techniques for electronic content delivery pacing based on multidimensional forecasting. Operational objectives of campaign pacing may include mitigating the following technical problems of a content delivery computer: a) failure to achieve a total delivery quota of a content delivery campaign, b) the delivery quota is fulfilled too early, and/or c) volatility of delivery fulfilment exceeds a natural volatility of opportunities to deliver content. Such technical problems in the execution of the content delivery computer may cause the content delivery computer to unnecessarily idle, which may waste technical resources needed for computer execution, such as processing cycles (i.e. time) and electricity. Campaign pacing techniques herein are technical solutions that quantitatively optimize delivery rate of a content delivery computer system by providing: a) increased utilization of a content delivery campaign, b) as a corollary of (a), try to avoid starvation of the content delivery campaign, and/or c) increased efficiency of usage of resource(s) of the content delivery computer.

For example, efficiency may be a statistic that is based on counts of interesting events (e.g. impressions, clicks, and/or conversions) that a content delivery campaign may provoke for some quantum of a limited resource as discussed later herein. Thus, campaign pacing may quantitatively increase the efficiency of a content delivery computer. For example without intelligent pacing, a campaign of wider applicability may eagerly, unnecessarily, and/or sub-optimally monopolize content delivery opportunities at times when a campaign of narrower applicability is falling short of delivery quota(s). For example without intelligent pacing, interference between campaigns may reduce system throughput and aggregate content delivery, even when content demand would naturally support delivering more content instead of less.

In an embodiment, a computer receives, for a content delivery campaign, targeting criteria and a resource usage limit of a limited resource. The targeting criteria may be multidimensional such as by specifying value ranges for attribute dimensions of entities, such as users associated with membership records of an online service or community. Entities that match the targeting criteria are identified for which content of the delivery campaign may have increased relevance.

For each matching entity, a forecast of requests that might originate from the entity during each of a series of time intervals is generated to predict opportunities to deliver the content of the campaign. The forecasts of the matching entities can be combined to generate a combined forecast of requests for the targeting criteria. The combined forecast may be a prediction of demand expected from the matching entities for the content of the delivery campaign.

The computer generates, based on the combined forecast and the resource usage limit for the content delivery campaign, and stores for future use a fulfilment schedule that specifies amounts of requests to fulfill during the series of time intervals. Delivery pacing is operational adherence to the fulfillment schedule generated for the content delivery campaign, which may be more or less confounded by forecast inaccuracies and needs dynamic adjustment. According to heuristics herein, delivery volume volatility may be shaped to increase delivery efficiency.

Campaign pacing techniques herein are technical solutions that improve the underlying operation of a content delivery computer itself. Quantitative improvements to performance of a content delivery computer provide increased utilization of a content delivery campaign, and increased efficiency of usage of resource(s) of the content delivery computer. By optimizing the delivery rate of the content delivery campaign, such as by pacing to reduce the campaign's delivery volatility, interference between multiple content delivery campaigns is reduced. The content delivery computer may use the reduced volatility for temporal load balancing, which prevents idling of the content delivery computer. When configured according to techniques herein, the content delivery computer delivers more relevant campaign content to more entities in a given duration of computer operation, which is improved computer performance. As compared to the state of the art, technical approaches herein improve sustained computer throughput, improve computer load balancing, and improve avoidance of computer idling.

### System Overview

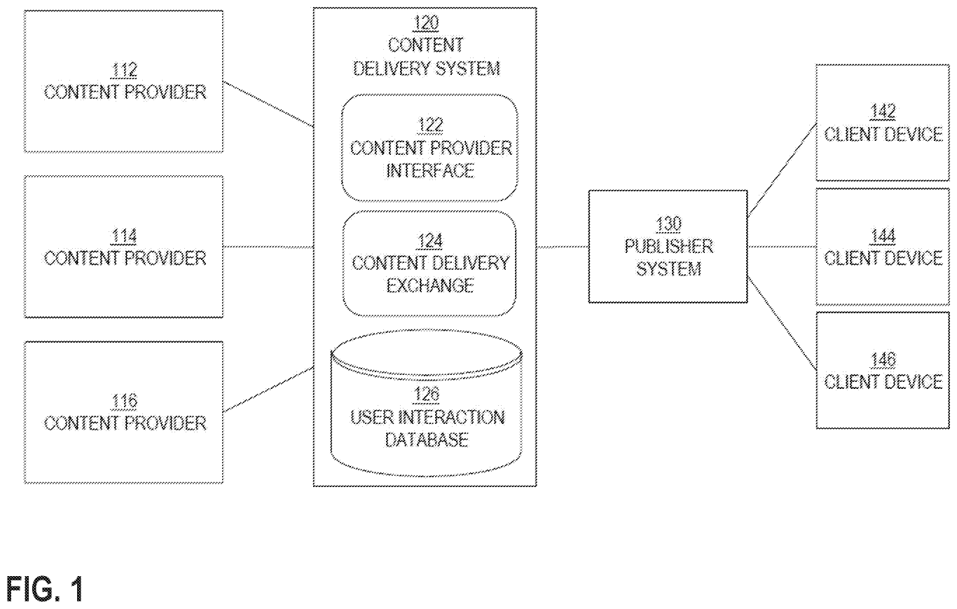

FIG. 1 is a block diagram that depicts a system 100 for distributing content items to one or more end-users, in an embodiment. System 100 includes content providers 112-116, a content delivery system 120, a publisher system 130, and client devices 142-146. Although three content providers are depicted, system 100 may include more or less content providers. Similarly, system 100 may include more than one publisher and more or less client devices.

Content providers 112-116 interact with content delivery system 120 (e.g., over a network, such as a LAN, WAN, or the Internet) to enable content items to be presented, through publisher system 130, to end-users operating client devices 142-146. Thus, content providers 112-116 provide content items to content delivery system 120, which in turn selects content items to provide to publisher system 130 for presentation to users of client devices 142-146. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery campaigns and (2) a content delivery exchange 124 that conducts content item selection events in response to content requests from a third-party content delivery exchange and/or from publisher systems, such as publisher system 130.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device. For example, a content item may indicate a need for a logistic resource, such as a vacant employment position, and the linked web page may show a job posting for that position.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 124, and that bids for space (on one or more publisher systems, such as publisher system 130) to present content items on behalf of multiple content providers. Thus, a bidder is another source of content items that content delivery exchange 124 may select for presentation through publisher system 130. Thus, a bidder acts as a content provider to content delivery exchange 124 or publisher system 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery system 120 through, for example, content provider interface 122. An example of content provider interface 122 is Campaign Manager™ provided by LinkedIn. Content provider interface 122 comprises a set of user interfaces that allow a representative of a content provider to create an account for the content provider, create one or more content delivery campaigns within the account, and establish one or more attributes of each content delivery campaign. Examples of campaign attributes are described in detail below.

A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select, or click on the set of content items, when a certain number of users purchase a product/service associated with the content delivery campaign or fill out a particular form on a website, or when a budget of the content delivery campaign has been exhausted.

A content delivery campaign may specify one or more targeting criteria that are used to determine whether to present a content item of the content delivery campaign to one or more users. (In most content delivery systems, targeting criteria cannot be so granular as to target individual members.) Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery campaign are not sent to the computing device.

Thus, content delivery exchange 124 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 124 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher system 130 may not satisfy targeting criteria of one content item of a campaign, the same content request may satisfy targeting criteria of another content item of the campaign.

Different content delivery campaigns that content delivery system 120 manages may have different charge models. For example, content delivery system 120 (or, rather, the entity that operates content delivery system 120) may charge a content provider of one content delivery campaign for each presentation of a content item from the content delivery campaign (referred to herein as cost per impression or CPM). Content delivery system 120 may charge a content provider of another content delivery campaign for each time a user interacts with a content item from the content delivery campaign, such as selecting or clicking on the content item (referred to herein as cost per click or CPC). Content delivery system 120 may charge a content provider of another content delivery campaign for each time a user performs a particular action, such as purchasing a product or service, downloading a software application, or filling out a form (referred to herein as cost per action or CPA). Content delivery system 120 may manage only campaigns that are of the same type of charging model or may manage campaigns that are of any combination of the three types of charging models.

A content delivery campaign may be associated with a resource budget that indicates how much the corresponding content provider is willing to be charged by content delivery system 120, such as $100 or $5,200. A content delivery campaign may also be associated with a bid amount (also referred to a “resource reduction amount”) that indicates how much the corresponding content provider is willing to be charged for each impression, click, or other action. For example, a CPM campaign may bid five cents for an impression (or, for example, $50 per 1000 impressions), a CPC campaign may bid five dollars for a click, and a CPA campaign may bid five hundred dollars for a conversion (e.g., a purchase of a product or service).

### Content Item Selection Events

As mentioned previously, a content item selection event is when multiple content items (e.g., from different content delivery campaigns) are considered and a subset selected for presentation on a computing device in response to a request. Thus, each content request that content delivery exchange 124 receives triggers a content item selection event.

For example, in response to receiving a content request, content delivery exchange 124 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 124 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery system 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 124 conducts one or more content item selection events. Thus, content delivery exchange 124 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that operates content delivery system 120 conducts one or more content item selection events. In this latter embodiment, content delivery system 120 sends one or more content items to the other exchange, which selects one or more content items from among multiple content items that the other exchange receives from multiple sources. In this embodiment, content delivery exchange 124 does not necessarily know (a) which content item was selected if the selected content item was from a different source than content delivery system 120 or (b) the bid prices of each content item that was part of the content item selection event. Thus, the other exchange may provide, to content delivery system 120, information regarding one or more bid prices and, optionally, other information associated with the content item(s) that was/were selected during a content item selection event, information such as the minimum winning bid or the highest bid of the content item that was not selected during the content item selection event.

### Event Logging

Content delivery system 120 may log one or more types of events, with respect to content item summaries, across client devices 142-146 (and other client devices not depicted). For example, content delivery system 120 determines whether a content item summary that content delivery exchange 124 delivers is presented at (e.g., displayed by or played back at) a client device. Such an “event” is referred to as an “impression.” As another example, content delivery system 120 determines whether a content item summary that exchange 124 delivers is selected by a user of a client device. Such a “user interaction” is referred to as a “click.” Content delivery system 120 stores such data as user interaction data, such as an impression data set and/or a click data set. Thus, content delivery system 120 may include a user interaction database 126. Logging such events allows content delivery system 120 to track how well different content items and/or campaigns perform.

For example, content delivery system 120 receives impression data items, each of which is associated with a different instance of an impression and a particular content item summary. An impression data item may indicate a particular content item, a date of the impression, a time of the impression, a particular publisher or source (e.g., onsite v. offsite), a particular client device that displayed the specific content item (e.g., through a client device identifier), and/or a user identifier of a user that operates the particular client device. Thus, if content delivery system 120 manages delivery of multiple content items, then different impression data items may be associated with different content items. One or more of these individual data items may be encrypted to protect privacy of the end-user.

Similarly, a click data item may indicate a particular content item summary, a date of the user selection, a time of the user selection, a particular publisher or source (e.g., onsite v. offsite), a particular client device that displayed the specific content item, and/or a user identifier of a user that operates the particular client device. If impression data items are generated and processed properly, a click data item should be associated with an impression data item that corresponds to the click data item. From click data items and impression data items associated with a content item summary, content delivery system 120 may calculate a CTR for the content item summary.

### User Segments

As noted above, a content provider may specify multiple targeting criteria for a content delivery campaign. Some content providers may specify only one or a few targeting criteria, while other content providers may specify many targeting criteria. For example, content delivery system 120 may allow content providers to select a value for each of twenty-five possible facets. Example facets include geography, industry, job function, job title, past job title(s), seniority, current employer(s), past employer(s), size of employer(s), years of experience, number of connections, one or more skills, organizations followed, academic degree(s), academic institution(s) attended, field of study, job function, language, years of experience, interests, and groups in which the user is a member.

In an embodiment, in order to provide an accurate forecast, delivery statistics are generated at a segment level, where each segment corresponds to a different combination of targeting dimensions, or a different combination of facet-value pairs. Some segments may be associated with multiple users while other segments may be associated with a single user. Because the number of different possible combinations of facet-value pairs is astronomically large, the number of segments is limited to segments/users that have initiated a content item selection event in the last N number of days, such as a week, a month, or three months.

### Pacing Computer

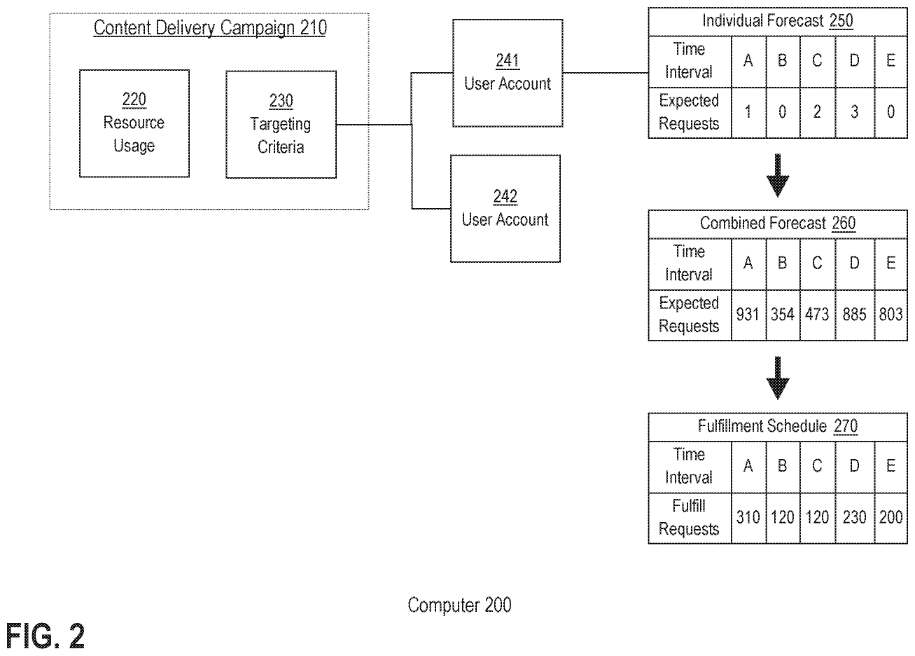

FIG. 2 is a block diagram that depicts example computer 200, in an embodiment. Based on multidimensional targeting and forecasting, computer 200 generates fulfillment schedule 270 that maintains a smooth pace of request fulfilment for content delivery campaign 210. Computer 200 may be an implementation of content delivery system 120. Computer 200 may be at least one rack server such as a blade, personal computer, virtual computer, or other networked computing device.

Content delivery campaign 210 contains content (not shown) that can be delivered to entities, such as operators of user accounts such as 241-242. Each of user accounts 241-242 may be a record such as a file, database record, or profile that contains various values. Each of user accounts 241-242 may represent a respective end user. Values stored in user accounts 241-242 may reflect attributes of the end user, including historical usage, personal history, demographics, personal interests, organizational affiliations, and/or relations to other user accounts. Some values stored in user accounts 241-242 may be timestamped to indicate recency of the values.

Content delivery campaign 210 contains targeting criteria 230 that restrict which user accounts might receive content of content delivery campaign 210. For example, campaign content may be a file or a text or binary artifact such as an image or document that may be delivered over a communication network (not shown) from computer 200 to a computing device (not shown) that is associated with a user account.

A client is an entity, such as an end user (not shown), that is associated with a user account and may operate a computing device to send, to computer 200, a request for content. For example, the end user's computing device may send a hypertext transfer protocol (HTTP) request such as from a web browser. Computer 200 may respond by sending the client a requested content.

Also in response, computer 200 may or may not send additional unrequested content such as content of content delivery campaign 210 that may be directly embedded in requested content or indirectly embedded into requested content as a reference, such as a uniform resource identifier (URI), such as a uniform resource locator (URL). For example, the client's computing device may need to send to computer 200 an additional content request based on the URL in order to retrieve content of content delivery campaign 210.

Thus, a unit of delivery of content of content delivery campaign 210 is content delivered once to one client, even though repeated delivery and/or broadcast/multicast delivery may occur in an embodiment. An impression is such a unit of delivery.

Resource usage 220 operates as a limit on how many impressions content delivery campaign 210 may have during a period such as a day and/or until content delivery campaign 210 expires. For example, resource usage 220 may specify that content delivery campaign 210 should have at most a hundred impressions per hour, a thousand impressions per day, and/or content delivery campaign 210 should cease after seven days and/or five thousand impressions. Based on such a delivery expectation of content delivery campaign 210, computer 200 may have various analytical challenges such as predicting how many impressions should respectively occur in each time interval A-E of fulfillment schedule 270 of content delivery campaign 210, such as respective fifteen-minute timespans.

In an embodiment, fulfillment schedule 270 may additionally or instead specify a monotonically increasing total amount of impressions that should be delivered in each time interval A-E. For example, if a hundred impressions should be delivered in each time interval A-E, then fulfillment schedule 270 may specify a hundred impression total for time interval A and a two hundred impression total for time interval B. That is, fulfillment schedule 270 may specify cumulative amounts instead of (or in addition to) incremental amounts.

Confounding factors may include imprecise forecasting of requested content demand in time intervals A-E and interference from other content delivery campaigns. In various embodiments, resource consumption may be weighted such that two impressions of a same content delivery campaign 210 may be counted differently when summing impressions. In an embodiment, money or other credit is a unit of weighting and/or accounting. In an embodiment, weight may be a fluctuating price that is centrally controlled, floating and fair, and/or individually calculated for each impression such as by multiple content delivery campaigns that bid at auction. For example, in a second price auction, a bidder wins with a highest bid, but the second highest bid sets the price of the impression.

Resource usage 220 and fulfillment schedule 270 may use impressions as units of measure. In an embodiment, resource usage 220 and fulfillment schedule 270 additionally or instead use money/credits as units of measure. For example, resource usage 220 may specify spending $100 per hour, and/or fulfillment schedule 270 may specify spending $50 in time interval A and $33 in time interval B that are each fifteen minutes. In an embodiment, allocation of impressions to time intervals A-E of fulfillment schedule 270 may be pessimistic, with a bias to eagerly deliver, such that delivering more in earlier time intervals of fulfillment schedule 270 and less in later time intervals may be specified instead of planning to deliver equal amounts of impressions in all time intervals A-E.

In an embodiment, user accounts 241-242 may each include registration of a respective user as a member of an audience of a same central website. However, content delivery campaign 210 may deliver content to those users through the central website and/or through other (e.g. third party) websites. In an embodiment, weighting of a request or costing of an impression is based on which website was involved and/or whether the website is the central website. For example, requests to the central website may weigh more (or less) than requests to other websites.

Fulfillment schedule 270 operates as a delivery plan to which adherence may be interfered by fluctuating operating conditions, such as varying amounts of content requests. Predictive accuracy of fulfillment schedule 270 is increased by deriving fulfillment schedule 270 from combined forecast 260 that predicts amounts of content requests during time intervals A-E from all user accounts 241-242 that match targeting criteria 230. Multidimensional request forecasting is discussed later herein.

Amounts of requests actually received from matching user accounts 241-242 may impose a natural limit on how much content delivery campaign 210 may deliver. Thus, impression limits specified by fulfillment schedule 270 usually should not exceed predictions of expected requests specified by combined forecast 260.

In an embodiment, combined forecast 260 aggregates forecasts for individual user accounts 241-242 that match targeting criteria 230. For example, individual forecast 250 contains amounts of expected requests by user account 241 for time intervals A-E.

When relevant traffic is forecasted to be low, forecasting accuracy may be relatively decreased. For example, combined forecast 260 may have fewer requests than a first threshold, or an amount of matching user accounts 241-242 may be fewer than a second threshold. To compensate for inaccuracy related to low volume, a pessimistic bias to eagerly deliver may be needed as discussed above.

### Pace Scheduling

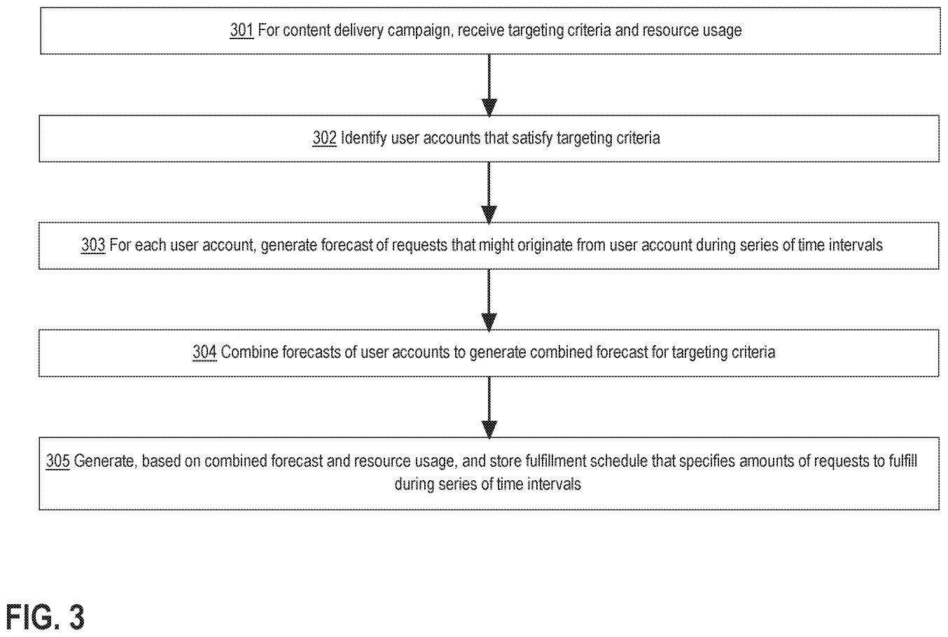

FIG. 3 is a flow diagram that depicts an example analytical process of computer 200 for calculating fulfillment schedule 270 for content delivery campaign 210, in an embodiment. FIG. 3 is discussed with reference to FIG. 2.

In an embodiment, the process of FIG. 3 is scheduled to run periodically, such as hourly or nightly, to regenerate fulfillment schedule 270 with updated values. Such periodicity need not correspond to a duration of one time interval of A-E nor an aggregation of time intervals A-E. Fault tolerance is increased when the periodicity of this process is less than the aggregate of time intervals A-E such that same fulfillment schedule 270 may still be used even when the process of FIG. 3 occasionally fails. Likewise, this process may account for impressions that already occurred for content delivery campaign 210.

Step 301 is preparatory. For content delivery campaign 210, step 301 receives targeting criteria 230 and resource usage 220 that may be originally obtained from a remote computer of an owner of content delivery campaign 210 (e.g., content provider 112) and/or locally obtained from a database or configuration file of computer 200.

Step 301 selects user accounts 241-242 that have multidimensional attributes that satisfy multidimensional targeting criteria 230. Targeting criteria 230 may specify inclusion and/or exclusion criteria that contain thresholds such as value ranges. For example, user accounts 241-242 may each have a respective postal zip code that satisfy a range of zip codes specified by targeting criteria 230.

Zip code is one possible dimension, and matching may entail multiple dimensions and value ranges. For example, step 301 may translate targeting criteria 230 into a multidimensional/compound filter expression such as a WHERE clause of a structured query language (SQL) SELECT query that can identify matching user accounts 241-242 for content delivery campaign 210. Thus, relevance of user accounts 241-242 to content delivery campaign 210 is increased or assured.

For each matching user account 241-242, step 303 generates an individual forecast of requests that might originate from the user account during time intervals A-E, such as individual forecast 250 for user account 241. Time intervals A-E may be a sliding window such that step 303 always forecasts a same amount of time intervals from the present time into the future. In an embodiment, request forecasting is based on request history of the user account and/or user account with similar user account dimension values that may or may not be unrelated to targeting criteria 230. Request forecasting is discussed later herein.

Step 304 combines individual forecasts, such as 250, of requests from matching user accounts 241-242 to generate combined forecast 260 of requests that match targeting criteria 230. In an embodiment, calculating combined forecast 260 directly sums individual forecasts of matching user accounts 241-242.

Step 305 generates, based on combined forecast 260 and resource usage 220, and stores fulfillment schedule 270 that specifies amounts of requests to fulfill during series of time intervals A-E. Steps 303 and 305 are predictive and may be implemented by respective predictive analytical models that may be tunable and/or trainable, such as a) multidimensional regressors (using techniques such as linear regression, random forest, XGBoost, neural networks, and/or deep learning), b) traditional time series based forecasting methods such as Simple Moving Average, Autoregressive Integration Moving Average etc., and/or c) a combination of both. Essentially, steps 303-304 cooperate to generate a predicted temporal curve of delivery opportunities for content delivery campaign 210.

Because delivery opportunities should exceed resource usage 220, step 305 should generate a predicted temporal curve of impressions for content delivery campaign 210 that is somewhat smooth in volatility and feasible within combined forecast 260. For example, combined forecast 260 may not support simply dividing resource usage 220 equally across time intervals A-E, and such uniformity may be undesirable such as due to predictably varied impression cost due to audience cycles such as time of day and/or day of week. For example, step 305 may adjust fulfillment schedule 270 according to phenomena such as prime time and dollar cost averaging.

The steps of FIG. 3 may be more or less decoupled from each other and have respective frequencies. For example, step 302 processes user account dimensions that may have a low volatility. For example, dimension values of user accounts 241-242 may seldom change, and running step 302 nightly may be sufficient.

Whereas, forecasting step 303 may run hourly for increased sensitivity to dynamically fluctuating conditions such as trends such as moving averages. Scheduling/pacing step 305 may run every few minutes, such as quarter hourly and/or according to time intervals A-E, to mediate multiple conditions that may be aggravating in combination, such as a sudden unexpected lack of audience in a current time interval after delivery shortfalls in recent time interval(s).

In an embodiment, time intervals A-E of individual forecast 250, combined forecast 260, and/or actual request history of an entire audience may be stored as rows in a database table. The following table shows examples of such table rows. In this example, there are 288 metric_request_X columns, each such column representing the number of requests in a 15 min timespan, and the table contains 3 days' worth of request data resulting in 288 (24*4*3) quarter-hour periods.

| timetamp | dimension_geo | . . . | dimension_skills | is_from_lan | campaign_type | metric_request_t0 | . . . | metric_request_t287 |
|---|---|---|---|---|---|---|---|---|
| 1540337979000 | [na.us, | . . . | [100, 200] | true | | 100 | . . . | 200 |
| | na.us.ca] | | | | | | | |
| 1540337979000 | [as.in] | . . . | [100, 200] | false | | 50 | . . . | 100 |

In an embodiment, the above table has a separate column for each targeting dimension, including dimensions used in targeting criteria 230. For example, targeting dimensions may include the following dimensions of user accounts such as 241-242.
dimension_skills
dimension_companiesAll
dimension_titles
dimension_companies
dimension_companySizes
dimension_degree
dimension_industries
dimension_audienceMatching
dimension_titlesPast
dimension_fieldOfStudy
dimension_dynamicSegment
dimension_customSegment
dimension_functions
dimension_gender
dimension_titlesAll
dimension_interfaceLanguage
dimension_yearsOfExperience
dimension_age
dimension_groups
dimension_companiesFollowed
dimension_companiesPast
dimension_education
dimension_firstDegreeConnectionCompanies
dimension_seniorities
dimension_geo
dimension_interestSegment
is_from_lan
campaign_type

For example, request history may indicate how many requests in a past time interval came from a user account of a person having a graduate degree, which targeting criteria 230 may target. For example, request forecasting that is based on past requests may tally interesting past requests with a database query such as: SELECT sum (metric_request_t0), sum(metric_request_t1), sum(metric_request_t287) FROM suPacingForecast WHERE campaign_type=22 AND is_from_lan=true AND dimension_geo in (“eu.gb.*.4573”) AND dimension_skills in (100, 200, 300). Here, the ellipsis ( . . . ) is a demonstrative abbreviation of sums of requests for many time interval columns. In an embodiment, such queries may be submitted to a remote database management system (DBMS) such as with representational state (REST) requests over HTTP.

For example, queries may be sent to a REST endpoint and may specify details such as a past or future duration and targeting criteria. In an embodiment, the result of each such query may also be pre-calculated “off-line” such as by a scheduled batch job. The result of each such query (one query per targeting expression of a content delivery campaign) may be stored in a DBMS and may be fetched at run time via a REST endpoint.

Sometimes it is possible that using all the dimensions listed earlier, can result in a very narrow fulfillment schedule, for example, if the dimension_geo is “Antarctica” and dimension_titles is “Director”. In such a case, we use a subset of the targeting dimensions to generate a fulfillment schedule that has more users, so that the fulfillment schedule is more accurate. In this scenario, we would just use dimension_geo, and drop the dimension_titles from the targeting dimensions to generate the fulfilment schedule.

### Database Table Generation

Depending on the scale of the content delivery system, and the number of users who are shown the content delivery campaign content, the database table that needs to be generated can contain anywhere from hundreds of thousands of rows to billions of rows. The fulfilment schedule needs to be recalculated on a daily basis, and the table needs to be populated since the daily traffic pattern influences the forecast for the upcoming days.

The database table is usually populated via “off-line” flows. The off-line flow may run on a cloud environment having thousands of machines. For example, a Hadoop map-reduce cluster, or an apache spark cluster could be used for this purpose.

Some content delivery campaigns only match to a few thousand users, while some match to hundreds of millions of users. To compute the combined forecast and the fulfillment schedule for such content delivery campaign that match millions of users, all the data computation cannot be done on a single computer, and the map-reduce clusters are used to partition the data, and compute small aggregates on multiple computers, progressively aggregating to compute a final combined forecast for each campaign.

Computing the small aggregates with partitioned data is also a CPU intensive task, and it can take hours or even days at times to both match the user entities to the content delivery campaigns, predict the combined forecast, and then aggregate it.

This data containing millions of rows is then stored into a database table for quick retrieval.

### Pacing Process

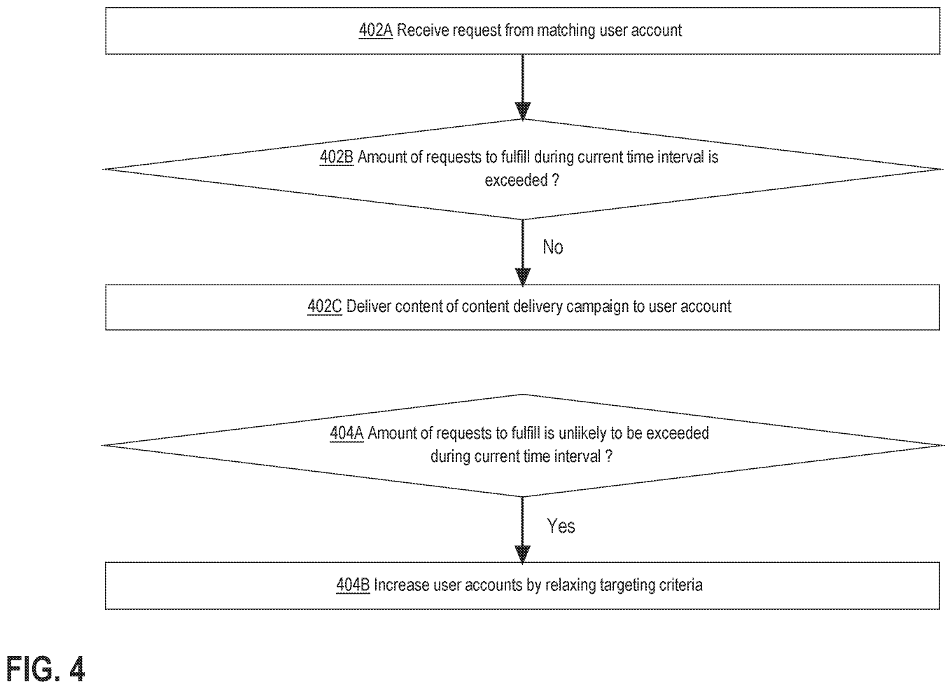

FIG. 4 is a flow diagram that depicts an example transactional process of computer 200 for using fulfillment schedule 270 to pace impressions of content delivery campaign 210, in an embodiment. FIG. 4 is discussed with reference to FIG. 2.

Unlike the process of FIG. 3 that may have scheduled periodicity, the process of FIG. 4 is event driven. Thus, this process is responsive to receiving a content request associated with a user account that matches targeting criteria 230 of content delivery campaign 210, which is shown as step 402A. Although not shown, before step 402A, computer 200 receives a request from any user account, which might not match targeting criteria 230,

Identification of the user account may be based on tracking mechanisms such as an HTTP session, an HTTP cookie, and/or a web browser fingerprint. For example, tracking information may be used as a lookup key for retrieving an identifier of a user account from a database, or the tracking information may directly contain the identifier. In an embodiment, a user account should be currently logged into a web/mobile application of computer 200 before the user account can be detected, which may entail interactive data entry such as an email address and/or a password.

With the user account identified, target matching may be detected. In various embodiments, an identifier of content delivery campaign 210 such as a hash code of distinctive attributes of campaign 210, an identifier of targeting criteria 230, or a specification of targeting criteria 230 may be used as a lookup key for retrieving a set of identifiers of matching user accounts 241-242 from a database. For example, the set of identifiers of matching user accounts 241-242 may have already been precomputed as a property of content delivery campaign 210 or of targeting criteria 230.

Thus when a request is received from user account 241, computer 200 may quickly detect whether or not user account 241 is targeted by content delivery campaign 210 and without comparing values of dimensions of user account 241 to values of dimensions of targeting criteria 230. Thus, targeting does not impose analytic latency on request execution.

If a user account of a request is not targeted by content delivery campaign 210, then step 402A and the process of FIG. 4 do not occur for the request with content delivery campaign 210. However, this process may still occur for the same request with a different content delivery campaign that does target the user account. In an embodiment, identifiers of content delivery campaigns that target a user account are precomputed as a property of the user account and may be inspected to decide which one or some of such content delivery campaigns to perform step 402A and the process of FIG. 4 for the request.

Step 402B performs impression pacing by detecting whether or not, in a current time interval of fulfillment schedule 270, an amount of impressions already delivered for content delivery campaign 210 in the current time interval exceeds a planned amount of requests to fulfill as specified by fulfilment schedule 270. Amounts may be measured as impressions or as credits. If the planned amount to fulfill is exceeded, then the process of FIG. 4 is halted for the request with content delivery campaign 210. However, this process may still occur for the same request with a different content delivery campaign that targets the same user account. In this way, impressions of content delivery campaign 210 may be throttled to an amount that is less than available delivery opportunities, which is essential to pacing.

Step 402B uses fulfilment schedule 270 that may be cached on computer 200 but persisted on another computer such as a datastore computer. Cached fulfilment schedule 270 may have an expiration, such as a time to live (TTL), that may cause eviction of fulfilment schedule 270 from cache. A least recently used (LRU) cache policy may also evict fulfilment schedule 270. Step 402B may handle a cache miss by sending the datastore computer a REST request to retrieve a latest version of fulfilment schedule 270, such as with parameters in the following table.

| Parameters | Description |
|---|---|
| campaignType | <Enum> (Text Ads, Sponsored Updates, Dynamic Ads) |
| timeRange | <Long, Long> [start,end] UTC epoch time in millis |
| targetingCriteria | <String> contains campaign targeting expression expressed in the |
| | form of included target segments and excluded target segments |
| placementType | <Enum> ONSITE_ONLY, ONSITE_LAN |
| granularity | <Enum> FIFTEEN_MINUTE |
| campaignId (optional) | <Long> if campaignId is passed in, campaign specific fields: |
| | (campaignType, targetingCriteria, lanEnabled) are not required, |
| | and it may make a DB call to get the information. |

The other computer may answer the retrieval request by returning fulfilment schedule 270, such as with fields in the following table.

| Field Name | Description |
|---|---|
| granularity | Denotes that the pacing forecast granularity is |
| | for fifteen minute interval. This field can also |
| | be used by lifetime pacing in the future for |
| | specifying day-level granularity |
| metricType | <Enum> REQUESTS, IMPRESSIONS, |
| CREDITS | The metric forecasted is the |
| | number value of the metric above for the |
| | given granularity of time window |
| timeRange | the time range for which the pacing forecast is |
| | being returned. Note that it might be different |
| | at times from the timeRange that was |
| | requested. |
| pacingForecastValues | An array of values of the metricType |
| | specified for the given timeRange in the |
| | specified granularity. The values represent |
| | the final pacing curve, with metrics from |
| | different placementTypes weighted and |
| | summed accordingly |

In an embodiment, computer 200 analyzes the fulfilment schedules for all of its content delivery campaigns while bootstrapping, so that it can immediately optimally pace the delivery of each content delivery campaign. Computer 200 may make multiple asynchronous REST calls (for example, for 50 campaigns at a time) in parallel to the datastore computer and fetch the fulfilment schedules of hundreds of thousands of content delivery campaigns and caches them in-memory.

In an embodiment, computer 200 should keep periodically fetching the latest fulfilment schedule, for example with a REST call to the datastore computer for each content delivery campaign once a day. Rather than make all the REST calls at the same time, which may cause undue instantaneous load on the datastore computer, computer 200 provides a random TTL for each content delivery campaign, so that all the campaigns fulfilment schedules expire at different times, and thus are fetched at different times from the datastore computer, thus not imposing a demand spike on the datastore computer.

In an embodiment, the datastore computer 1000 asynchronously responds to the retrieval request from computer 200. That is, step 402B may send the retrieval request but not wait for the response to provide a latest version of fulfilment schedule 270. In that case, computer 200 may instead use an expired version of fulfilment schedule 270, so long as the expired version includes needed time intervals, such as a current time interval and/or some time intervals in the near future. If an expired version is unavailable or all of its time intervals A-E have already elapsed, then a default schedule may be used, such as one that expects an equal amount of impressions in every time interval. A default schedule may be temporarily sufficient because the other computer may send the latest fulfilment schedule 270 soon, such as while the current time interval is still occurring.

Regardless of whether or not step 402B detects whether excess delivery of the content delivery campaign 210 has occurred, computer 200 delivers requested content to the requesting client. However, step 402B decides whether or not the unrequested content of content delivery campaign 210 should also be delivered (in step 402C).

If step 402B does not detect excess delivery of content delivery campaign 210, then step 402C occurs, which involves delivering content of content delivery campaign 210 to user account 241. For example, a URL to campaign content may be embedded into the requested content that is sent to the client. For example, the requested content may be a web page, and the embedded URL may specify a graphical image of content delivery campaign 210, such as a clickable banner and/or accompanying downloadable logic such as dynamic hypertext markup language (DHTML) including asynchronous JavaScript and XML (AJAX, extensible markup language) and/or JavaScript object notation (JSON).

In an embodiment, step 402C has two phases. First, content delivery campaign 210 places a bid in a real time bidding (RTB) auction or content item selection event. Second and only if content delivery campaign 210 wins the auction, step 402C embeds campaign content as discussed above.

Indeed, content delivery campaign 210 may lose many or most auctions. If the bid fails, then the process of FIG. 4 is halted for the request with content delivery campaign 210. However, this process may still occur for the same request with a different content delivery campaign that targets the user account.

For example, multiple content delivery campaigns that target a same user account may more or less simultaneously submit respective bids to a content item selection event for the same request. In other words, computer 200 may host content delivery campaigns that compete for access to a same audience.

As discussed, steps 402A-B provide typical request handling by content delivery campaign 210, including throttling when needed. Steps 404A-B provide special processing for boundary cases. For example, underutilization may cause content delivery campaign 210 to fall behind in fulfilment schedule 270. Depending on the embodiment, steps 404A-B may occur as part of the same process as steps 402A-C or may, with or without a current request, be caused by separate events or separate schedules, such as subintervals within a current time interval of fulfilment schedule 270.

Step 404A predicts whether or not enough targeted requests may still occur to satisfy fulfilment schedule 270 during a current time interval. For example, a first half of the current time interval may elapse with very few impressions, which step 404A may detect. In an embodiment, step 404A predicts, based on how much of the current time interval remains and how much of the current time interval's quota has been fulfilled, a probability that the current time interval of fulfilment schedule 270 will have sufficient impressions. Step 404A detects whether or not the probability falls beneath a threshold.

If step 404A detects underutilization, then step 404B occurs to accelerate utilization of content delivery campaign 210. Step 404B may include various actions that are progressively applied until utilization sufficiently increases. In an embodiment, step 404B causes content delivery campaign 210 to target additional user accounts by relaxing targeting criteria.

For example, progressive activities may sequentially include: expanding a value range of a dimension of targeting criteria 230, removing the dimension from targeting criteria 230, increasing a relative priority of content delivery campaign 210 to preempt delivery opportunities from other content delivery campaigns of computer 200, and paying more per impression such as with enhanced bids. Such adjustments made by step 404A may be temporary, such as only for a current time interval of fulfilment schedule 270 or until throttling occurs in a same or later time interval.

In an embodiment, such utilization boosting adjustments are made directly by step 404B. In an embodiment, such adjustments are instead made by whatever process periodically regenerates fulfilment schedule 270. For example, utilization boosting adjustments may be performed by either process of FIGS. 3-4 and may or may not be based on active performance and delivery monitoring of a current time interval of fulfilment schedule 270.

### Statistical Pacing

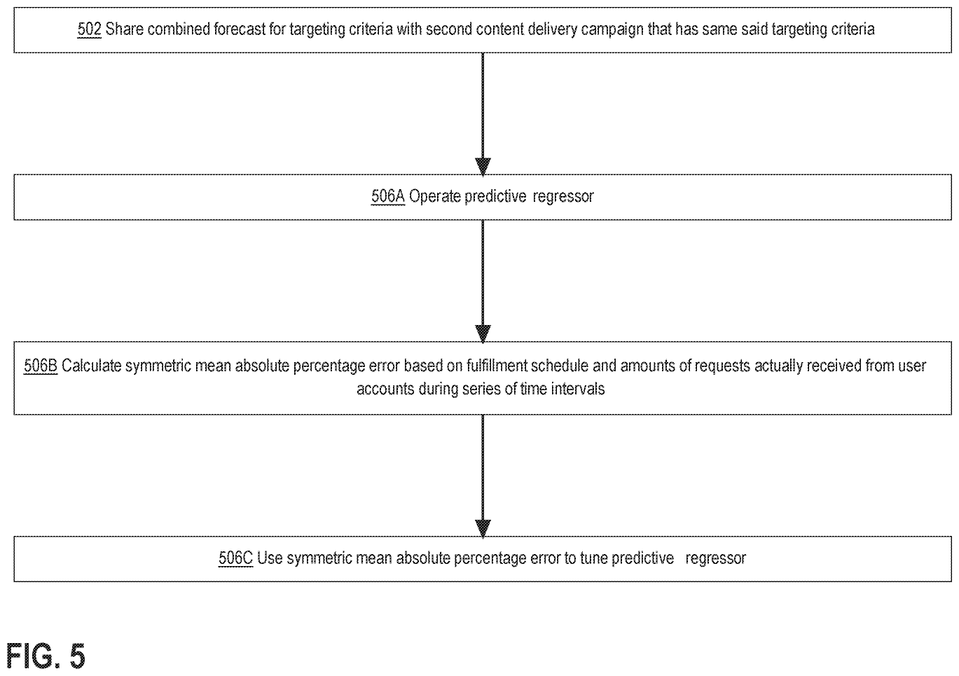

FIG. 5 is a flow diagram that depicts an example analytical process of computer 200 for generating fulfillment schedule 270 to pace impressions of content delivery campaign 210, in an embodiment. FIG. 5 is discussed with reference to FIG. 2.

Step 502 shares combined forecast 260 for multiple content delivery campaigns that have same targeting criteria. Each content delivery campaign may have a unique fulfillment schedule, such as 270. However, a combined forecast, such as 260, is based on particular targeting criteria, such as 230, that may coincidentally/unintentionally be the same for multiple content delivery campaigns, such as 210.

For example, two content delivery campaigns may share same targeting criteria 230 and same combined forecast 260 but not share a same fulfillment schedule, such as when both content delivery campaigns have different resource usages, such as 220. Thus, both content delivery campaigns may target a same set of user accounts, such as 241-242.

Steps 506A-C improve forecasting and/or pacing by tuning. Step 506A operates a predictive regressor, such as a linear regressor or a logistic regressor, to calculate individual forecast 250 or fulfillment schedule 270. Later when fulfillment schedule 270 is at least partially elapsed, step 506B compares actual requests or impressions versus predicted requests or impressions in any elapsed time intervals A-E to measure prediction accuracy.

In an embodiment, the predictive regressor calculates an autoregressive integrated moving average (ARIMA) of historical requests from user account 241, such as for forecasting. ARIMA may extrapolate a trend that has a future amount of requests that is both influenced by, and distinct from, a past amount of requests. ARIMA has a moving average to reveal a trend. ARIMA has autoregression for smoothing. For example, any of individual forecast 250, combined forecast 260, and/or fulfillment schedule 270 may be based on ARIMA forecasting.

In an embodiment, step 506B calculates a symmetric mean absolute percentage error (SMAPE) based on comparing fulfillment schedule 270 or combined forecast 260 to amounts of requests actually received from user accounts during any elapsed time intervals A-E. A granularity of a SMAPE calculation may or may not be limited to a content delivery campaign, a user account, a targeting dimension, or a market segment. Thus, campaign centric accuracy estimation for multidimensional pacing may be achieved.

Accuracy beneath a threshold may indicate a need to tune or recalibrate the predictive regressor. For example, the predictive regressor may apply weights to inputs, and those weights may need adjustment. In an embodiment, the predictive regressor is trainable such as by reinforcement learning. For example, actual requests or impressions during any elapsed time intervals A-E, such as recorded in a database or console log, may eventually be added to a corpus of training samples for training the predictive regressor.

In an embodiment, step 506C uses the calculated SMAPE error value to tune the predictive regressor. For example, a magnitude of a change of a weight may be proportional to a magnitude of the SMAPE value.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

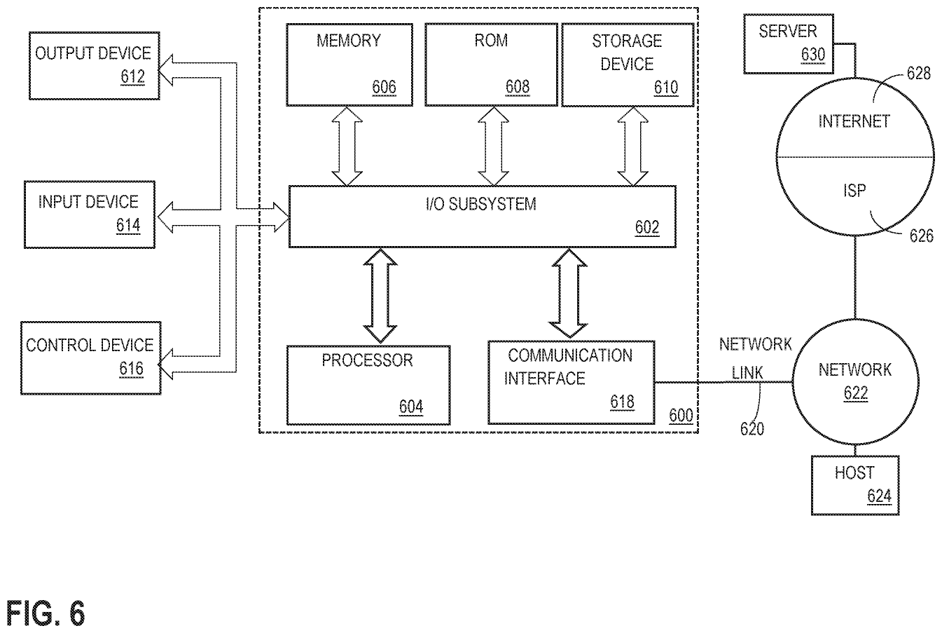

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, for a content delivery campaign, targeting criteria and a resource usage;
identifying a plurality of entities that satisfy the targeting criteria;
generating, for each entity of the plurality of entities, a forecast of requests that might originate from the entity during each time interval of a series of time intervals;
combining the forecasts of the plurality of entities to generate a combined forecast for the targeting criteria;
generating, based on the combined forecast and the resource usage, a fulfilment schedule for the content delivery campaign that specifies amounts of requests to fulfill during the series of time intervals;
wherein the method is performed by one or more computers.

2. The method of claim 1 further comprising:
receiving a request from an entity of the plurality of entities;
detecting whether said amount of requests to fulfill during a current time interval of the series of time intervals of the fulfillment schedule is exceeded;
delivering, when said detecting said amount is not exceeded, content of the content delivery campaign to the entity.

3. The method of claim 2 wherein said detecting whether said amount of requests is not exceeded comprises:
detecting said amount is unlikely to be exceeded during the current time interval, and
increasing the plurality of entities by relaxing one of the targeting criteria.

4. The method of claim 1 wherein a first sum of said amounts of requests to fulfil during a first half of the series of time intervals exceeds a second sum of said amounts of requests to fulfil during a second half of the series of time intervals.

5. The method of claim 4 further comprising causing the first sum of said amounts of requests to exceed the second sum of said amounts of requests when a count of the plurality of entities does not exceed a threshold.

6. The method of claim 1 wherein said requests that might originate from the entity comprises a weighted sum of requests.

7. The method of claim 1 further comprising sharing the combined forecast for the targeting criteria with a second content delivery campaign that has same said targeting criteria.

8. The method of claim 1 wherein said generating the forecast of requests that might originate from the entity comprises calculating an autoregressive integrated moving average of historical requests from the entity.

9. The method of claim 1 wherein:
said generating the fulfilment schedule comprises operating a predictive regressor;
the method further comprises:
calculating a symmetric mean absolute percentage error based on the fulfilment schedule that specifies amounts of requests to fulfill during the series of time intervals and amounts of requests actually received from the plurality of entities during the series of time intervals, and
using the symmetric mean absolute percentage error to tune the predictive regressor.

10. The method of claim 1 wherein the targeting criteria for the content delivery campaign comprises an indication of: recency, demography, and/or geography.

11. One or more non-transitory computer-readable media storing instructions that, when executed by one or more processors, cause:
receiving, for a content delivery campaign, targeting criteria and a resource usage;
identifying a plurality of entities that satisfy the targeting criteria;
generating, for each entity of the plurality of entities, a forecast of requests that might originate from the entity during each time interval of a series of time intervals;
combining the forecasts of the plurality of entities to generate a combined forecast for the targeting criteria;
generating, based on the combined forecast and the resource usage, a fulfilment schedule for the content delivery campaign that specifies amounts of requests to fulfill during the series of time intervals.

12. The one or more non-transitory computer-readable media of claim 11 wherein the instructions further cause:
receiving a request from an entity of the plurality of entities;
detecting whether said amount of requests to fulfill during a current time interval of the series of time intervals of the fulfillment schedule is exceeded;
delivering, when said detecting said amount is not exceeded, content of the content delivery campaign to the entity.

13. The one or more non-transitory computer-readable media of claim 12 wherein said detecting whether said amount of requests is not exceeded comprises:
detecting said amount is unlikely to be exceeded during the current time interval, and
increasing the plurality of entities by relaxing one of the targeting criteria.

14. The one or more non-transitory computer-readable media of claim 11 wherein a first sum of said amounts of requests to fulfil during a first half of the series of time intervals exceeds a second sum of said amounts of requests to fulfil during a second half of the series of time intervals.

15. The one or more non-transitory computer-readable media of claim 14 wherein the instructions further cause the first sum of said amounts of requests to exceed the second sum of said amounts of requests when a count of the plurality of entities does not exceed a threshold.

16. The one or more non-transitory computer-readable media of claim 11 wherein said requests that might originate from the entity comprises a weighted sum of requests.

17. The one or more non-transitory computer-readable media of claim 11 wherein the instructions further cause sharing the combined forecast for the targeting criteria with a second content delivery campaign that has same said targeting criteria.

18. The one or more non-transitory computer-readable media of claim 11 wherein said generating the forecast of requests that might originate from the entity comprises calculating an autoregressive integrated moving average of historical requests from the entity.

19. The one or more non-transitory computer-readable media of claim 11 wherein:
said generating the fulfilment schedule comprises operating a predictive regressor;
the instructions further cause:
calculating a symmetric mean absolute percentage error based on the fulfilment schedule that specifies amounts of requests to fulfill during the series of time intervals and amounts of requests actually received from the plurality of entities during the series of time intervals, and
using the symmetric mean absolute percentage error to tune the predictive regressor.

20. The one or more non-transitory computer-readable media of claim 11 wherein the targeting criteria for the content delivery campaign comprises an indication of: recency, demography, and/or geography.
